(19) United States
(12) Patent Application Publication
(10) Pub. No.: US 2017/0149282 A1
(43) Pub. Date: May 25, 2017

(54) WIRELESS POWER TRANSFER RECEIVER HAVING SYNCHRONOUS RECTIFIER SYNCHRONIZED TO WIRELESS POWER TRANSFER SIGNAL

(71) Applicant: QUALCOMM INCORPORATED, SAN DIEGO, CA (US)

(72) Inventors: Paolo Menegoli, San Jose, CA (US); Gabriel Isaac Mayo, North Potomac, MD (US)

(21) Appl. No.: 15/182,650

(22) Filed: Jun. 15, 2016

Related U.S. Application Data
(60) Provisional application No. 62/259,253, filed on Nov. 24, 2015.

(51) Int. Cl. H02J 50/12; H02J 7/02; H02J 3/01; H02J 7/04

(52) U.S. Cl. CPC H02J 50/12; H02J 7/045; H02J 7/025; H02J 3/01

(57) ABSTRACT

An apparatus for wirelessly receiving power via a wireless field generated by a transmitter includes a resonator configured to generate electrical current to power or charge a load based on a voltage induced in the resonator in response to the wireless field, a controller configured to receive a synchronization timing reference signal based on a derivative of the voltage induced in the resonator, the controller configured to generate a rectifier control signal based on the synchronization timing reference signal, and a synchronous rectifier configured to switch responsive to the rectifier control signal.

### RELATED APPLICATIONS

This application claims the benefit of U.S. Provisional Patent Application No. 62/259,253, entitled “Wireless Power Transfer Receiver Having Synchronous Rectifier Synchronized To Wireless Power Transfer Signal,” filed Nov. 24, 2015, the contents of which are hereby incorporated by reference in their entirety.

### FIELD

The present disclosure relates generally to wireless power. More specifically, the disclosure is directed to a wireless power receiver having a synchronous rectifier synchronized to a wireless power transfer signal.

### BACKGROUND

An increasing number and variety of electronic devices are powered via rechargeable batteries. Such devices include mobile phones, portable music players, laptop computers, tablet computers, computer peripheral devices, communication devices (e.g., Bluetooth devices), digital cameras, hearing aids, and the like. While battery technology has improved, battery-powered electronic devices increasingly require and consume greater amounts of power, thereby often requiring recharging. Rechargeable devices are often charged via wired connections that require cables or other similar connectors that are physically connected to a power supply. Cables and similar connectors may sometimes be inconvenient or cumbersome and have other drawbacks. Wireless charging systems that are capable of transferring power in free space to be used to charge rechargeable electronic devices may overcome some of the deficiencies of wired charging solutions. As such, wireless charging systems and methods that efficiently and safely transfer power for charging rechargeable electronic devices are desirable.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides an apparatus for wirelessly receiving power via a wireless field generated by a transmitter includes a resonator configured to generate electrical current to power or charge a load based on a voltage induced in the resonator in response to the wireless field, a controller configured to receive a synchronization timing reference signal based on a derivative of the voltage induced in the resonator, the controller configured to generate a rectifier control signal based on the synchronization timing reference signal, and a synchronous rectifier configured to switch responsive to the rectifier control signal.

Another aspect of the disclosure provides a method for wirelessly receiving power via a wireless field generated by a transmitter including generating an electrical current to power or charge a load based on a voltage induced in a resonator in response to the wireless field, generating a synchronization timing reference signal based on a derivative of the voltage induced in the resonator, generating a rectifier control signal based on the synchronization timing reference signal, and receiving the rectifier control signal and based thereon, providing a regulated voltage.

Another aspect of the disclosure provides a device for wirelessly receiving power via a wireless field generated by a transmitter including means for generating an electrical current to power or charge a load based on a voltage induced in response to the wireless field, means for generating a synchronization timing reference signal based on a derivative of the voltage induced in the means for generating the electrical current, means for generating a rectifier control signal based on the synchronization timing reference signal, and means for receiving the rectifier control signal and based thereon, providing a regulated voltage.

Another aspect of the disclosure provides an apparatus for wirelessly receiving power via a wireless field generated by a transmitter including a resonator configured to generate electrical current to power or charge a load based on a voltage induced in the resonator in response to the wireless field, a controller configured to receive a synchronization timing reference signal based on a derivative of the voltage induced in the resonator, the controller configured to generate a first control signal configured to control a first switch and a second control signal configured to control a second switch, and a synchronous rectifier configured to receive the first control signal and the second control signal and configured to provide a regulated voltage.

### BRIEF DESCRIPTION OF THE DRAWINGS

In the figures, like reference numerals refer to like parts throughout the various views unless otherwise indicated. For reference numerals with letter character designations such as “102a” or “102b”, the letter character designations may differentiate two like parts or elements present in the same figure. Letter character designations for reference numerals may be omitted when it is intended that a reference numeral encompass all parts having the same reference numeral in all figures.

FIG. 1 is a functional block diagram of an exemplary wireless power transfer system, in accordance with exemplary embodiments.

FIG. 2 is a functional block diagram of exemplary components that may be used in the wireless power transfer system of FIG. 1, in accordance with various exemplary embodiments.

FIG. 3 is a schematic diagram of a portion of transmit circuitry or receive circuitry of FIG. 2 including a transmit or receive antenna, in accordance with exemplary embodiments.

FIG. 4 is a functional block diagram of a transmitter that may be used in the wireless power transfer system of FIG. 1, in accordance with exemplary embodiments.

FIG. 5 is a functional block diagram of a receiver that may be used in the wireless power transfer system of FIG. 1, in accordance with exemplary embodiments.

FIG. 6 is a schematic diagram of a portion of transmit circuitry that may be used in the transmit circuitry of FIG. 4.

FIG. 7 is a block diagram showing an exemplary embodiment of a portion of a wireless power receiver including a rectifier control circuit.

FIG. 8 is a timing diagram showing the timing of various signals of FIG. 7.

FIG. 9 is a block diagram showing an exemplary alternative embodiment of the wireless power receiver of FIG. 7.

FIG. 10 is a timing diagram showing the timing of various signals of FIG. 9.

FIG. 11 is a timing diagram showing a detail of a trace representing the signal at node C of FIG. 9 and a trace representing the current in the first switch of FIG. 9.

FIG. 12 is a timing diagram showing a detail of a trace representing the signal at node C of FIG. 9 and a trace representing the voltage across the first switch of FIG. 9.

FIG. 13 is a flowchart illustrating an exemplary embodiment of a method for controlling a synchronous rectifier in a wireless power receiver.

FIG. 14 is a functional block diagram of an apparatus for controlling a synchronous rectifier in a wireless power receiver.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The detailed description set forth below in connection with the appended drawings is intended as a description of exemplary embodiments and is not intended to represent the only embodiments in which the invention may be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments. In some instances, some devices are shown in block diagram form.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal). Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving antenna” to achieve power transfer.

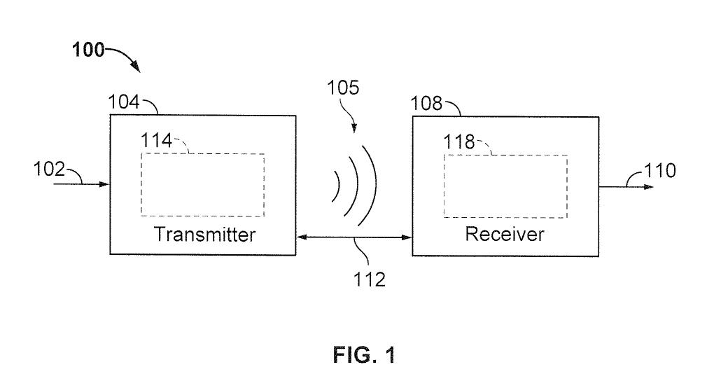

FIG. 1 is a functional block diagram of an exemplary wireless power transfer system 100, in accordance with exemplary embodiments. Input power 102 may be provided to a transmitter 104 from a power source (not shown) for generating a field 105 (e.g., magnetic or species of electromagnetic) for providing energy transfer. A receiver 108 may couple to the field 105 and generate output power 110 for storing or consumption by a device (not shown) coupled to the output power 110. Both the transmitter 104 and the receiver 108 are separated by a distance 112. In one exemplary embodiment, transmitter 104 and receiver 108 are configured according to a mutual resonant relationship. When the resonant frequency of receiver 108 and the resonant frequency of transmitter 104 are substantially the same or very close, transmission losses between the transmitter 104 and the receiver 108 are reduced. As such, wireless power transfer may be provided over larger distances in contrast to purely inductive solutions that may require large coils to be very close (e.g., millimeters). Resonant inductive coupling techniques may thus allow for improved efficiency and power transfer over various distances and with a variety of inductive coil configurations.

The receiver 108 may receive power when the receiver 108 is located in an energy field 105 produced by the transmitter 104. The field 105 corresponds to a region where energy output by the transmitter 104 may be captured by a receiver 108. The transmitter 104 may include a transmit antenna 114 (that may also be referred to herein as a coil) for outputting an energy transmission. The receiver 108 further includes a receive antenna 118 (that may also be referred to herein as a coil) for receiving or capturing energy from the energy transmission. In some cases, the field 105 may correspond to the “near-field” of the transmitter 104. The near-field may correspond to a region in which there are strong reactive fields resulting from the currents and charges in the transmit antenna 114 that minimally radiate power away from the transmit antenna 114. In some cases the near-field may correspond to a region that is within about one wavelength (or a fraction thereof) of the transmit antenna 114.

In accordance with the above therefore, in accordance with more particular embodiments, the transmitter 104 may be configured to output a time varying magnetic field 105 with a frequency corresponding to the resonant frequency of the transmit antenna 114. When the receiver is within the field 105, the time varying magnetic field 105 may induce a voltage in the receive antenna 118 that causes an electrical current to flow through the receive antenna 118. As described above, if the receive antenna 118 is configured to be resonant at the frequency of the transmit antenna 114, energy may be more efficiently transferred. The AC signal induced in the receive antenna 118 may be rectified to produce a DC signal that may be provided to charge or to power a load.

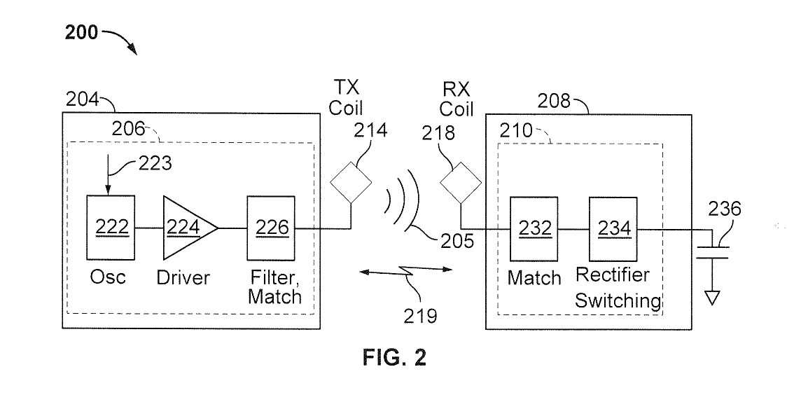

FIG. 2 is a functional block diagram of exemplary components in a wireless power transfer system 200 that may be used in the wireless power transfer system 100 of FIG. 1, in accordance with various exemplary embodiments. The transmitter 204 may include transmit circuitry 206 that may include an oscillator 222, a driver circuit 224, and a filter and matching circuit 226. The oscillator 222 may be configured to generate a signal at a desired frequency, such as 468.75 KHz, 6.78 MHz or 13.56 MHz, that may be adjusted in response to a frequency control signal 223. The oscillator signal may be provided to a driver circuit 224 configured to drive the transmit antenna 214 at, for example, a resonant frequency of the transmit antenna 214. The driver circuit 224 may be a switching amplifier configured to receive a square wave from the oscillator 222 and output a sine wave. For example, the driver circuit 224 may be a class E amplifier. A filter and matching circuit 226 may be also included to filter out harmonics or other unwanted frequencies and match the impedance of the transmitter 204 to the impedance of the transmit antenna 214. As a result of driving the transmit antenna 214, the transmitter 204 may wirelessly output power at a level sufficient for charging or powering an electronic device. As one example, the power provided may be for example on the order of 300 milliWatts to 5 Watts or 5 Watts to 40 Watts to power or charge different devices with different power requirements. Higher or lower power levels may also be provided.

The receiver 208 may include receive circuitry 210 that may include a matching circuit 232 and a rectifier and switching circuit 234 to generate a DC power output from an AC power input to charge a battery 236 as shown in FIG. 2 or to power a device (not shown) coupled to the receiver 208. The matching circuit 232 may be included to match the impedance of the receive circuitry 210 to the impedance of the receive antenna 218. The receiver 208 and transmitter 204 may additionally communicate on a separate communication channel 219 (e.g., Bluetooth, zigbee, cellular, etc.). The receiver 208 and transmitter 204 may alternatively communicate via in-band signaling using characteristics of the wireless field 205.

The receiver 208 may initially have a selectively disablable associated load (e.g., battery 236), and may be configured to determine whether an amount of power transmitted by transmitter 204 and received by receiver 208 is appropriate for charging a battery 236. Further, receiver 208 may be configured to enable a load (e.g., battery 236) upon determining that the amount of power is appropriate.

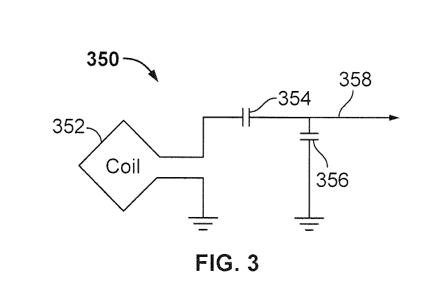

FIG. 3 is a schematic diagram of a portion of transmit circuitry 206 or receive circuitry 210 of FIG. 2 including a transmit or receive antenna 352, in accordance with exemplary embodiments. As illustrated in FIG. 3, transmit or receive circuitry 350 used in exemplary embodiments including those described below may include an antenna 352. The antenna 352 may also be referred to or be configured as a “loop” antenna 352. The antenna 352 may also be referred to herein or be configured as a “magnetic” antenna or an induction coil. The term “antenna” generally refers to a component that may wirelessly output or receive energy for coupling to another “antenna.” The antenna 352 may also be referred to as a coil of a type that is configured to wirelessly output or receive power. As used herein, an antenna 352 is an example of a “power transfer component” of a type that is configured to wirelessly output and/or receive power. The antenna 352 may be configured to include an air core or a physical core such as a ferrite core (not shown).

The antenna 352 may form a portion of a resonant circuit configured to resonate at a resonant frequency. The resonant frequency of the loop or magnetic antenna 352 is based on the inductance and capacitance. Inductance may be simply the inductance created by the antenna 352, whereas, capacitance may be added to create a resonant structure (e.g., a capacitor may be electrically connected to the antenna 352 in series or in parallel) at a desired resonant frequency. As a non-limiting example, capacitor 354 and capacitor 356 may be added to the transmit or receive circuitry 350 to create a resonant circuit that resonates at a desired frequency of operation. For larger diameter antennas, the size of capacitance needed to sustain resonance may decrease as the diameter or inductance of the loop increases. As the diameter of the antenna increases, the efficient energy transfer area of the near-field may increase. Other resonant circuits formed using other components are also possible. As another non-limiting example, a capacitor (not shown) may be placed in parallel between the two terminals of the antenna 352. For transmit antennas, a signal 358 with a frequency that substantially corresponds to the resonant frequency of the antenna 352 may be an input to the antenna 352. For receive antennas, the signal 358 may be the output that may be rectified and used to power or charge a load.

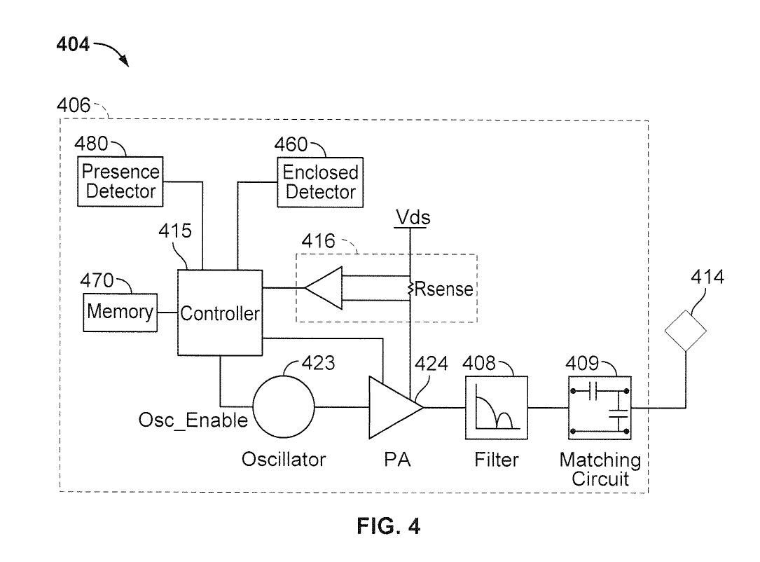

FIG. 4 is a functional block diagram of a transmitter 404 that may be used in the wireless power transfer system of FIG. 1, in accordance with exemplary embodiments. The transmitter 404 may include transmit circuitry 406 and a transmit antenna 414. The transmit antenna 414 may be the antenna 352 as shown in FIG. 3. The transmit antenna 414 may be configured as the transmit antenna 214 as described above in reference to FIG. 2. In some implementations, the transmit antenna 414 may be a coil (e.g., an induction coil). In some implementations, the transmit antenna 414 may be associated with a larger structure, such as a pad, table, mat, lamp, or other stationary configuration. Transmit circuitry 406 may provide power to the transmit antenna 414 by providing an oscillating signal resulting in generation of energy (e.g., magnetic flux) about the transmit antenna 414. Transmitter 404 may operate at any suitable frequency. By way of example, transmitter 404 may operate at the 6.78 MHz ISM band.

Transmit circuitry 406 may include a fixed impedance matching circuit 409 for matching the impedance of the transmit circuitry 406 (e.g., 50 ohms) to the impedance of the transmit antenna 414 and a low pass filter (LPF) 408 configured to reduce harmonic emissions to levels to prevent self-jamming of devices coupled to receivers 108 (FIG. 1). Other exemplary embodiments may include different filter topologies, including but not limited to, notch filters that attenuate specific frequencies while passing others and may include an adaptive impedance match, that may be varied based on measurable transmit metrics, such as output power to the antenna 414 or DC current drawn by the driver circuit 424. Transmit circuitry 406 further includes a driver circuit 424 configured to drive a signal as determined by an oscillator 423. The transmit circuitry 406 may be comprised of discrete devices or circuits, or alternately, may be comprised of an integrated assembly.

Transmit circuitry 406 may further include a controller 415 for selectively enabling the oscillator 423 during transmit phases (or duty cycles) for specific receivers, for adjusting the frequency or phase of the oscillator 423, and for adjusting the output power level for implementing a communication protocol for interacting with neighboring devices through their attached receivers. It is noted that the controller 415 may also be referred to herein as a processor. The controller 415 may be coupled to a memory 470. Adjustment of oscillator phase and related circuitry in the transmission path may allow for reduction of out of band emissions, especially when transitioning from one frequency to another.

The transmit circuitry 406 may further include a load sensing circuit 416 for detecting the presence or absence of active receivers in the vicinity of the near-field generated by transmit antenna 414. By way of example, a load sensing circuit 416 monitors the current flowing to the driver circuit 424, that may be affected by the presence or absence of active receivers in the vicinity of the field generated by transmit antenna 414 as will be further described below. Detection of changes to the loading on the driver circuit 424 are monitored by controller 415 for use in determining whether to enable the oscillator 423 for transmitting energy and to communicate with an active receiver.

The transmit antenna 414 may be implemented with a Litz wire or as an antenna strip with the thickness, width and metal type selected to keep resistive losses low.

The transmitter 404 may gather and track information about the whereabouts and status of receiver devices that may be associated with the transmitter 404. Thus, the transmit circuitry 406 may include a presence detector 480, an enclosed detector 460, or a combination thereof, connected to the controller 415 (also referred to as a processor herein). The controller 415 may adjust an amount of power delivered by the driver circuit 424 in response to presence signals from the presence detector 480 and the enclosed detector 460. The transmitter 404 may receive power through a number of power sources, such as, for example, an AC-DC converter (not shown) to convert AC power present in a building, a DC-DC converter (not shown) to convert a DC power source to a voltage suitable for the transmitter 404, or directly from a DC power source (not shown).

As a non-limiting example, the presence detector 480 may be a motion detector utilized to sense the initial presence of a device to be charged that is inserted into the coverage area of the transmitter 404. After detection, the transmitter 404 may be turned on and the power received by the device may be used to toggle a switch on the receiver device in a pre-determined manner, which in turn results in changes to the driving point impedance of the transmitter 404.

As another non-limiting example, the presence detector 480 may be a detector capable of detecting a human, for example, by infrared detection, motion detection, or other suitable means. In some exemplary embodiments, there may be regulations limiting the amount of power that a transmit antenna 414 may transmit at a specific frequency. In some cases, these regulations are meant to protect humans from electromagnetic radiation. However, there may be environments where a transmit antenna 414 is placed in areas not occupied by humans, or occupied infrequently by humans, such as, for example, garages, factory floors, shops, and the like. If these environments are free from humans, it may be permissible to increase the power output of the transmit antenna 414 above the normal power restrictions regulations. In other words, the controller 415 may adjust the power output of the transmit antenna 414 to a regulatory level or lower in response to human presence and adjust the power output of the transmit antenna 414 to a level above the regulatory level when a human is outside a regulatory distance from the wireless charging field of the transmit antenna 414.

As a non-limiting example, the enclosed detector 460 (may also be referred to herein as an enclosed compartment detector or an enclosed space detector) may be a device such as a sense switch for determining when an enclosure is in a closed or open state. When a transmitter is in an enclosure that is in an enclosed state, a power level of the transmitter may be increased.

In exemplary embodiments, a method by which the transmitter 404 does not remain on indefinitely may be used. In this case, the transmitter 404 may be programmed to shut off after a user-determined amount of time. This feature prevents the transmitter 404, notably the driver circuit 424, from running long after the wireless devices in its perimeter are fully charged. This event may be due to the failure of the circuit to detect the signal sent from either the repeater or the receive antenna 218 that a device is fully charged. To prevent the transmitter 404 from automatically shutting down if another device is placed in its perimeter, the transmitter 404 automatic shut off feature may be activated only after a set period of lack of motion detected in its perimeter. The user may be able to determine the inactivity time interval, and change it as desired. As a non-limiting example, the time interval may be longer than that needed to fully charge a specific type of wireless device under the assumption of the device being initially fully discharged.

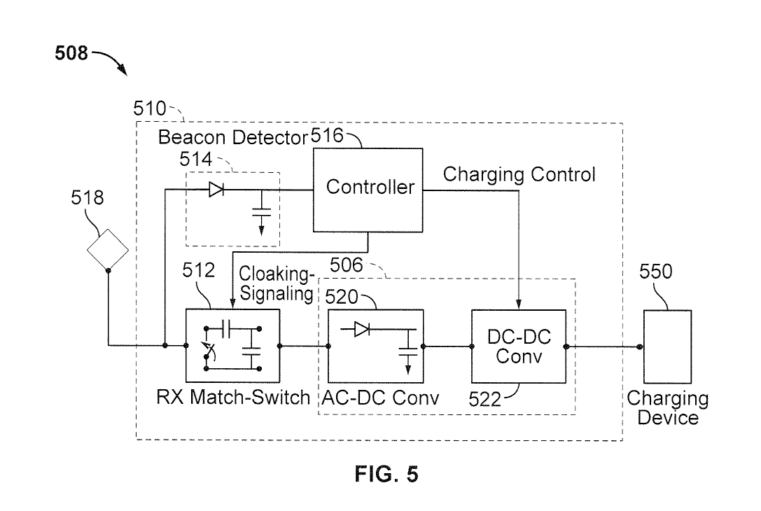

FIG. 5 is a functional block diagram of a receiver 508 that may be used in the wireless power transfer system of FIG. 1, in accordance with exemplary embodiments. The receiver 508 includes receive circuitry 510 that may include a receive antenna 518. Receiver 508 further couples to device 550 for providing received power thereto. It should be noted that receiver 508 is illustrated as being external to device 550 but may be integrated into device 550. Energy may be propagated wirelessly to receive antenna 518 and then coupled through the rest of the receive circuitry 510 to device 550. By way of example, the charging device may include devices such as mobile phones, portable music players, laptop computers, tablet computers, computer peripheral devices, communication devices (e.g., Bluetooth devices), digital cameras, hearing aids (and other medical devices), wearable devices, and the like.

Receive antenna 518 may be tuned to resonate at the same frequency, or within a specified range of frequencies, as transmit antenna 414 (FIG. 4). Receive antenna 518 may be similarly dimensioned with transmit antenna 414 or may be differently sized based upon the dimensions of the associated device 550. By way of example, device 550 may be a portable electronic device having diametric or length dimension smaller than the diameter or length of transmit antenna 414. In such an example, receive antenna 518 may be implemented as a multi-turn coil in order to reduce the capacitance value of a tuning capacitor (not shown) and increase the receive coil's impedance. By way of example, receive antenna 518 may be placed around the substantial circumference of device 550 in order to maximize the antenna diameter and reduce the number of loop turns (i.e., windings) of the receive antenna 518 and the inter-winding capacitance.

Receive circuitry 510 may provide an impedance match to the receive antenna 518. Receive circuitry 510 includes power conversion circuitry 506 for converting received energy into charging power for use by the device 550. Power conversion circuitry 506 includes an AC-to-DC converter 520 and may also include a DC-to-DC converter 522. AC-to-DC converter 520 rectifies the energy signal received at receive antenna 518 into a non-alternating power with an output voltage. The DC-to-DC converter 522 (or other power regulator) converts the rectified energy signal into an energy potential (e.g., voltage) that is compatible with device 550 with an output voltage and output current. Various AC-to-DC converters are contemplated, including partial and full rectifiers, regulators, bridges, doublers, as well as linear and switching converters.

Receive circuitry 510 may further include RX matching and switching circuitry 512 for connecting receive antenna 518 to the power conversion circuitry 506 or alternatively for disconnecting the power conversion circuitry 506. Disconnecting receive antenna 518 from power conversion circuitry 506 not only suspends charging of device 550, but also changes the “load” as “seen” by the transmitter 404 (FIG. 2).

When multiple receivers 508 are present in a transmitter's near-field, it may be desirable to adjust the loading and unloading of one or more receivers to enable other receivers to more efficiently couple to the transmitter. A receiver 508 may also be cloaked in order to eliminate coupling to other nearby receivers or to reduce loading on nearby transmitters. This “unloading” of a receiver is also known herein as a “cloaking.” Furthermore, this switching between unloading and loading controlled by receiver 508 and detected by transmitter 404 may provide a communication mechanism from receiver 508 to transmitter 404. Additionally, a protocol may be associated with the switching that enables the sending of a message from receiver 508 to transmitter 404. By way of example, a switching speed may be on the order of 100 μsec.

In an exemplary embodiment, communication between the transmitter 404 and the receiver 508 may take place either via an “out-of-band” separate communication channel/antenna or via “in-band” communication that may occur via modulation of the field used for power transfer.

Receive circuitry 510 may further include signaling detector and beacon circuitry 514 used to identify received energy fluctuations that may correspond to informational signaling from the transmitter to the receiver. Furthermore, signaling and beacon circuitry 514 may also be used to detect the transmission of a reduced signal energy (i.e., a beacon signal) and to rectify the reduced signal energy into a nominal power for awakening either un-powered or power-depleted circuits within receive circuitry 510 in order to configure receive circuitry 510 for wireless charging.

Receive circuitry 510 further includes controller 516 for coordinating the processes of receiver 508 described herein including the control of RX matching and switching circuitry 512 described herein. It is noted that the controller 516 may also be referred to herein as a processor. Cloaking of receiver 508 may also occur upon the occurrence of other events including detection of an external wired charging source (e.g., wall/USB power) providing charging power to device 550. Controller 516, in addition to controlling the cloaking of the receiver, may also monitor beacon circuitry 514 to determine a beacon state and extract messages sent from the transmitter 404. Controller 516 may also adjust the DC-to-DC converter 522 for improved performance.

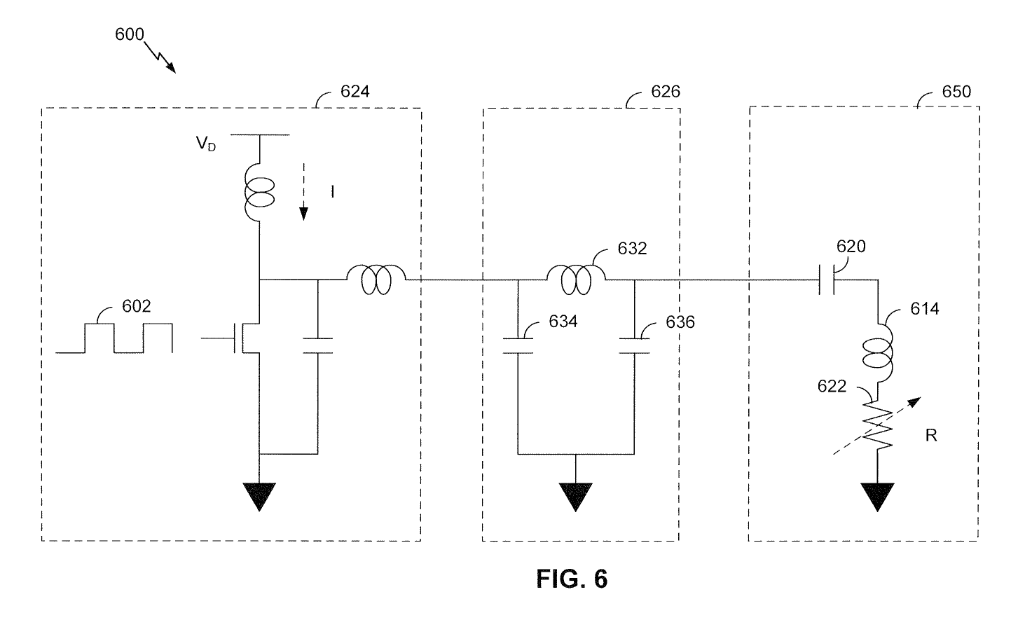

FIG. 6 is a schematic diagram of a portion of transmit circuitry 600 that may be used in the transmit circuitry 406 of FIG. 4. The transmit circuitry 600 may include a driver circuit 624 as described above in FIG. 4. As described above, the driver circuit 624 may be a switching amplifier that may be configured to receive a square wave and output a sine wave to be provided to the transmit circuit 650. In some cases the driver circuit 624 may be referred to as an amplifier circuit. The driver circuit 624 is shown as a class E amplifier, however, any suitable driver circuit 624 may be used in accordance with embodiments. The driver circuit 624 may be driven by an input signal 602 from an oscillator 423 as shown in FIG. 4. The driver circuit 624 may also be provided with a drive voltage V_{D} that is configured to control the maximum power that may be delivered through a transmit circuit 650. To eliminate or reduce harmonics, the transmit circuitry 600 may include a filter circuit 626. The filter circuit 626 may be a three pole (capacitor 634, inductor 632, and capacitor 636) low pass filter circuit 626.

The signal output by the filter circuit 626 may be provided to a transmit circuit 650 comprising an antenna 614. The transmit circuit 650 may include a series resonant circuit having a capacitance 620 and inductance (e.g., that may be due to the inductance or capacitance of the antenna or to an additional capacitor component) that may resonate at a frequency of the filtered signal provided by the driver circuit 624. The load of the transmit circuit 650 may be represented by the variable resistor 622. The load may be a function of a wireless power receiver 508 that is positioned to receive power from the transmit circuit 650.

In an exemplary embodiment, it is desirable to have the ability to control the output power provided by a wireless power receiver. In an exemplary embodiment, controlling the output power provided by a wireless power receiver controls the amount of charge provided to a charge-receiving device coupled to the wireless power receiver 508. In an exemplary embodiment, controlling the output power provided by a wireless power receiver may comprise regulating the voltage and/or the current at an output of a wireless power receiver. Generally, a wireless power receiver includes a way of converting the received power from an AC signal to a direct current (DC) signal. Regulating the load voltage or current, and in particular the charging of a battery coupled to the wireless power receiver, may be performed by a linear or switching DC-DC converter and dedicated circuitry that transform the energy from the output of the rectifier of the wireless power receiver to the desired load.

One of the ways that AC-DC conversion is implemented is through the use of what is referred to as a synchronous rectifier. In general, a synchronous rectifier uses actively controlled switches to convert the AC signal to a DC signal. One of the challenges when implementing a synchronous rectifier is controlling the switches so that the efficiency of the AC-DC conversion process is maximized.

In general, it is desirable to turn on (close) the switch, or switches, in the synchronous rectifier when there is zero voltage across the switch (this is sometimes referred to as zero voltage switching (ZVS)) and it is desirable to turn off (open) the switch, or switches, in the synchronous rectifier when there is zero current across the switch (this is sometimes referred to as zero current switching (ZCS)). A comparator across each switch may be used to detect the ZV and the ZC points to control the switches. However, while the turn on point, ZV, is relatively easily detected by a comparator across the switch because the comparator overdrive is larger when the switch is off, the turn off point ZC is more difficult to detect because the voltage across the switch at the ZC point is relatively small when the switch is turned on.

In an exemplary embodiment, a wireless power receiver has a synchronous rectifier that includes one or more switches that are synchronized to the wireless power transfer signal received at a wireless power receiver.

In an exemplary embodiment, the wireless power transfer signal may comprise a resonant voltage signal generated by a resonator in the wireless power receiver. The resonant voltage signal is used to develop synchronization points to drive the one or more switches in the rectifier.

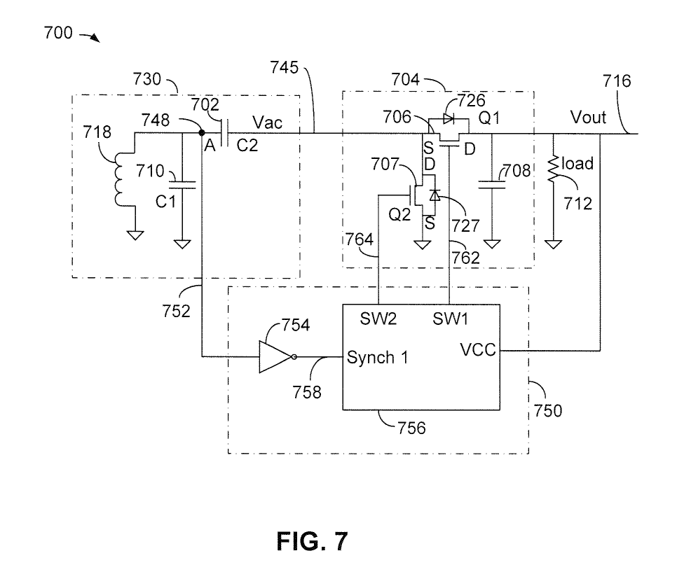

FIG. 7 is a block diagram showing an exemplary embodiment of a portion of a wireless power receiver 700 including a rectifier control circuit. The wireless power receiver 700 comprises portions of the receiver 508 of FIG. 5 that are relevant to the description of the rectifier control system described herein.

In an exemplary embodiment, the wireless power receiver 700 comprises a receive coil 718 coupled to and a part of a resonant tank circuit 730. In an exemplary embodiment, the resonant tank circuit 730 comprises fixed value and adjustable value components that can be configured to allow the receive coil 718 to operate at a resonant frequency. The receive coil 718 may be an embodiment of any of the receive antennas described herein, such as the receive antenna 518 of FIG. 5.

In an exemplary embodiment, the resonant tank circuit 730 is configured as a half bridge circuit comprising a capacitor 702 and a capacitor 710. In an exemplary embodiment, the term “resonator” is intended to apply to an antenna or a coil that is coupled to one or more capacitors such that the resonant frequency of the resonator is, at least in part, determined by the value of the capacitor or capacitors to which it is coupled. In an exemplary embodiment, the value of the capacitor 702 and the capacitor 710 can be chosen to tune the frequency of the receive coil 718 to a resonant frequency. The tuning of the wireless power receiver 700 can be affected by the location of the wireless power receiver 700 on a wireless charging surface, such as a transmitter pad, by nearby metal, and by the presence of other receivers, devices, etc. Using the capacitor 702 and the capacitor 710 to tune the resonant frequency of the receive coil 718 can help increase magnetic coupling between a transmit resonator and the receive coil 718 and thus increase total power available from a given wireless power system.

In an exemplary embodiment, the wireless power receiver 700 also comprises a rectifier circuit 704, a resistor 712 representing a load, and a rectifier control circuit 750. The rectifier circuit 704 may be coupled to the capacitor 702 over connection 745. While shown in FIG. 7 as a half bridge circuit having a half bridge rectifier, the circuitry and rectifier circuit 704 of FIG. 7 may be implemented as a full bridge circuit having a full bridge rectifier.

In an exemplary embodiment, the rectifier control circuit 750 comprises a buffer (also referred to as an inverter) 754 and a synchronous controller 756.

The rectifier circuit 704 comprises a first switch (Q1) 706, a second switch (Q2) 707, and a capacitor 708. The first switch 706 may incorporate a body diode 726 and the second switch 707 may incorporate a body diode 727.

The specifications of the first switch 706, the second switch 707, and the capacitor 708 are dependent on the application. As such a variety of rectifier topologies are contemplated. In an exemplary embodiment, the rectifier circuit 704 comprises a synchronous rectifier and the first switch 706 and the second switch 707 may be implemented using metal oxide semiconductor field effect transistor (MOSFET) switches, and the rectifier circuit 704 can be an embodiment of the AC-DC converter 520 shown in FIG. 5.

The resistor 712 represents a load across the DC output voltage, Vout, that appears at connection 716. In an exemplary embodiment, the load may comprise a rechargeable battery configured to power the device in which the wireless power receiver 700 is located. Alternatively, the load may comprise any device, application, or process configured to receive and/or operate using wirelessly received power.

In an exemplary embodiment, the signal at node A 748, may comprise the wireless power receive signal embodied as a resonant voltage signal. The signal at node A 748 can be used as an input to the synchronous controller 756 through the buffer 754. In an exemplary embodiment, the signal at node A 748 can be a generally sinusoidal waveform of the resonant voltage signal developed by the receive coil 718 (FIG. 7). Alternatively, the signal at node A 748 can be, for example, sampled with a comparator, sampled with an amplifier, or can be otherwise obtained. In an exemplary embodiment, the signal on node A 748 is provided over connection 752 to the buffer 754. The buffer 754 detects the signal on connection 752 and provides an input to the synchronous controller 756 over connection 758. The signal on connection 758 can be referred to as a synchronization timing reference signal, referred to as “synch 1” in FIG. 7.

The synchronous controller 756 receives the regulated output voltage, Vout, on connection 716 as a VCC voltage signal, and responsive to the synchronization timing reference signal on connection 758, generates a first rectifier control signal, SW1, on connection 762 and a second rectifier control signal, SW2, on connection 764 to control the respective first switch 706 and second switch 707. In an exemplary embodiment, the first rectifier control signal, SW1, is applied to the gate of the first switch 706 and the second rectifier control signal, SW2, is applied to the gate of the second switch 707.

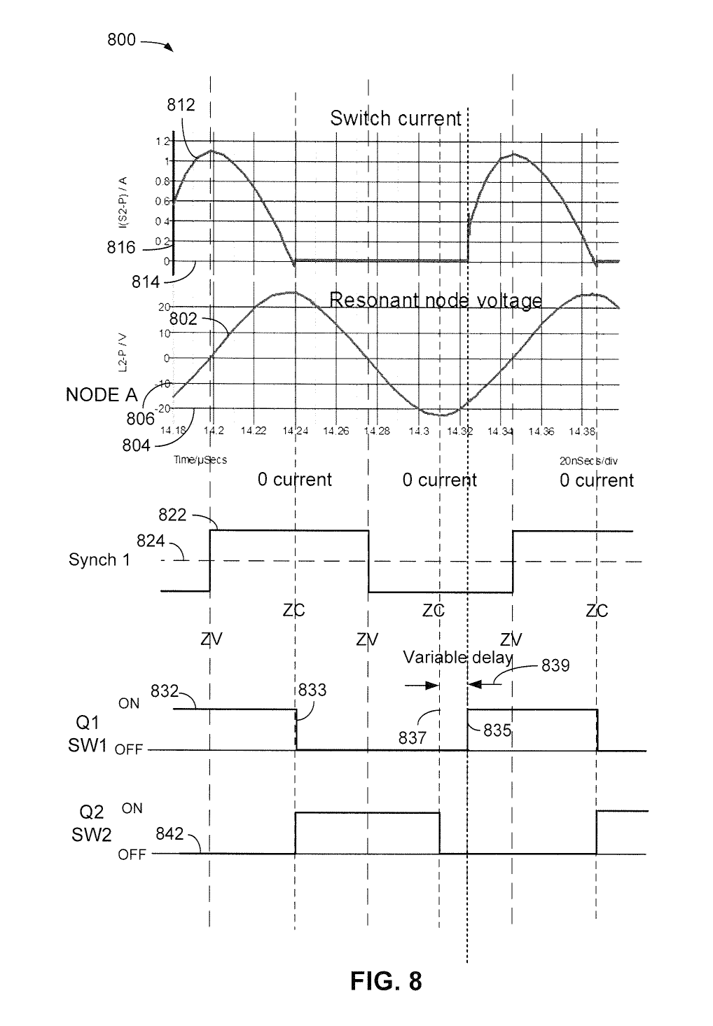

FIG. 8 is a timing diagram 800 showing the timing of various signals of FIG. 7. The timing diagram 800 shows a trace 802 showing the voltage at node A 748 (FIG. 7). The horizontal axis 804 shows time increasing to the right and the vertical axis 806 shows voltage. The trace 802 is a generally sinusoidal waveform of the resonant voltage signal developed by the receive coil 718 (FIG. 7).

The timing diagram 800 also shows a trace 812 showing the current in the first switch 706 (FIG. 7). The horizontal axis 814 shows time increasing to the right and the vertical axis 816 shows current.

A trace 822 represents the synchronization timing reference signal on connection 758 at the output of the buffer 754 (FIG. 7), and corresponds to the trace 802 where the zero crossing of the trace 802 is reflected by transitions across the axis 824 of the trace 822. The trace 822 is represented as a substantially square wave signal for simplicity of illustration with the axis 824 corresponding to zero voltage.

The trace 832 shows the first rectifier control signal, SW1, and the trace 842 shows the second rectifier control signal, SW2, developed by the synchronous controller 756 (FIG. 7). At a time prior to the time indicated by reference numeral 833, the first switch 706 is on and delivers a DC current component to connection 716 (FIG. 7), as indicated by the trace 812. During this time prior to time 833, the second switch 707 is off, as indicated by the trace 842. The time 833 corresponds to a time at which the voltage at node A 748 is maximum, and the current is at zero, also referred to as the ZC (zero current) point. At the point 833, the first rectifier control signal, SW1, causes the first switch 706 to be turned off and the second rectifier control signal, SW2, causes the second switch 707 to be turned on, which causes no current to be present at the output on connection 716 (FIG. 7), as also shown by the trace 812.

The first rectifier control signal, SW1, causes the first switch 706 to remain off until the time indicated by reference numeral 835. As shown by the trace 832, the time indicated by reference numeral 835 is located a time after the time indicated by reference numeral 837, which corresponds to a minimum of the voltage at node A 748, as shown by the trace 802. The variable delay period 839 between the time 837 and the time 835 may be chosen so that the first rectifier control signal, SW1, turns on the first switch 706 at a time after the ZC point indicated by reference numeral 837. The variable delay 839 represents a period of time when both the first switch 706 and the second switch 707 are off. The variable delay 839 establishes a phase displacement between the rectifier control signal on connection 762 (trace 832 in FIG. 8) (and 764 (trace 842 in FIG. 8) (FIG. 7) and the synchronization timing reference signal on connection 758 (trace 822 in FIG. 8). The variable delay 839 ensures that the first switch 706 is switched on only after the voltage at node A 748 is increasing. In an exemplary embodiment, the variable delay 839 provides a way of controlling output power by controlling the voltage and/or the current transformation through the rectifier circuit 704 by determining the time that the first switch 706 is turned on and the second switch 707 is turned off with respect to the trace 802. In an exemplary embodiment, the synchronization timing reference signal on connection 758 (FIG. 7) provides a way of using the wireless power signal in the receive coil 718 as the source of synchronization for the rectifier circuit 704.

In an exemplary embodiment, the variable delay 839 is optional and shows an exemplary embodiment of a way of controlling output power by allowing any amount of variable delay 839 to provide any phase displacement (phase angle difference) between the synchronization timing reference signal 758 (and the resonator voltage shown by trace 802) and the time that the first switch 706 is turned on and the second switch 707 is turned off. Providing this phase displacement between the ZC point of the trace 802 and the time that the first switch 706 is turned on and the second switch 707 is turned off allows control over the amount of power (voltage and/or current) provided through the rectifier circuit 704. In an exemplary embodiment, the switching phase of the rectifier circuit 704 is controlled by introducing the variable delay 839, or phase shift, with respect to the ZC point of the trace 802 and the turn on of the first switch 706 and/or the turn off of the second switch 707. The variable delay 839 can be provided by, for example, a phase locked loop (PLL) a delay locked loop (DLL) or another type of variable delay as a way of varying the synchronous phase.

The ZV and the ZC points are illustrated as examples only any arbitrary phase displacement between the synchronization timing reference signal on connection 758 (FIG. 7) and the turn on of the first switch 706 and/or the turn off of the second switch 707, whether positive or negative with respect to the ZC point of the trace 802, can be used. In an exemplary embodiment, synchronizing the rectifier circuit 704 to the receive coil 718 at node A 748, provides proper switching timing (therefore also allows a variable delay) in order to operate the rectifier circuit 704 as a synchronous rectifier. Further, applying a rectifier current phase shift using the variable delay 839 allows control over the output power as well as the ability to control or to optimize efficiency.

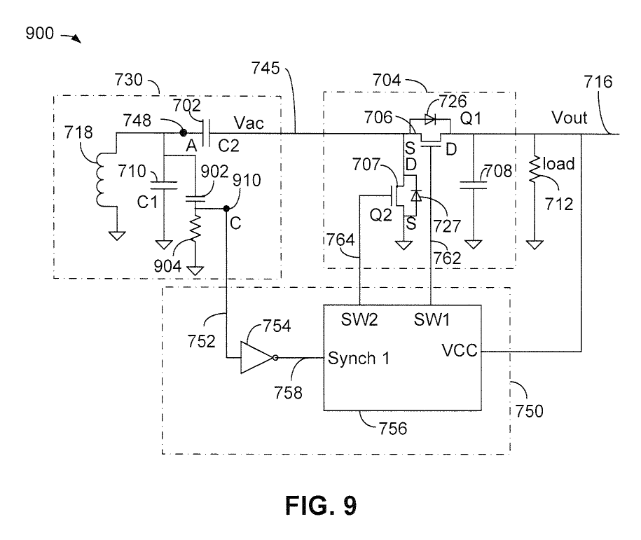

FIG. 9 is a block diagram showing an exemplary alternative embodiment of the wireless power receiver of FIG. 7. The wireless power receiver 900 is similar to the wireless power receiver 700 of FIG. 7, and elements in FIG. 9 that are identical to elements in FIG. 7 will not be described again.

In FIG. 9, the signal at node A 748 represents the sinusoidal voltage developed by the receive coil 718 as discussed with reference to FIG. 7. In an exemplary embodiment, the point on the trace 802 (FIG. 8) that corresponds to the ZC point (the point at which it is desired to turn off the first switch 706 in this example) is also the point of the maximum voltage of the sinusoidal voltage developed by the receive coil 718. In an exemplary embodiment, it may be desirable to have the ability to have the ZC point coincide with a point on the trace other than the sinusoidal voltage maximum of the trace 802. In an exemplary embodiment, the wireless power receiver 900 comprises a circuit comprising a capacitive element, such as a capacitor 902 and a resistive element, such as a resistor 904. The values of the capacitor 902 and a resistor 904 can be chosen such that the derivative of the voltage at node A 748 appears at a node C 910 located between the capacitor 902 and the resistor 904. Because the voltage at the node C 910 corresponds to the derivative of the voltage at the node A 748, a sinusoidal signal representing the voltage at node C 910 will cross the zero voltage point at the same point in time that the voltage at node A 748 reaches its maximum peak and its minimum peak. In an exemplary embodiment, a value of 1 pF for the capacitor 902 and a value of 1 kΩ for the resistor 904 can be used to extract the zero point of the voltage trace 802 without introducing excessive delay. The selection of the proper values also reduces the voltage to a desired value. The RC time constant in addition to providing a derivative action introduces a delay and a voltage attenuation of the signal at node C 910 with respect to the signal at node A 748. However with proper component value selection the delay can be minimized and the voltage attenuation can be set at a desirable value.

When the first switch 706 and the second switch 707 are off, there is a large voltage (and a large resistance) between the drain and source of each switch, such that turning on the first switch 706 or the second switch 707 at the ZC (zero current) point 833 can be accomplished with simple switching logic. Ideally, the switches should turn on when voltage between the drain and the source of the switch is zero. This condition generally occurs when the voltage at the input to rectifier circuit 704 becomes equal to the voltage at the output of the rectifier circuit 704. This leads to a voltage signal having a high slope, which makes detection of the switching point easy because the input and output voltages are approaching the same value.

However, when the first switch 706 and the second switch 707 are on, there is a small voltage (and a small resistance) across the drain and source of each switch. It is desirable to turn the first switch 706 and the second switch 707 off when the voltage between the drain and source of each switch is zero, or close to zero, and when there is no current flowing through the switch. When the switches are on and it is desired to turn the switches off, there are just a few millivolts of voltage difference between the input to rectifier circuit 704 and the output of the rectifier circuit 704 (and between the drain and source of each switch), so it is difficult to accurately measure the ZC (zero current) point. The derivative of the voltage at the antenna is at or near zero volts at the zero current point (or zero voltage condition across the first switch 706 and the second switch 707 when the switches are on) and can be accurately determined and used as the reference point in time to turn the switches off. Therefore, just before the turn off, the point at which the switches conduct zero current corresponds to the point at which there is zero voltage across the switch.

The measurement of the voltage across the drain and source of the switch when the switch is on can be characterized as a current measurement, leveraging the small on resistance of the switch. It is desirable to measure the zero current transition of the switch rather than zero voltage. However, the zero current transition of the switch may be difficult to measure as it results in a small signal, prone to noise susceptibility. Further, the small voltage difference across the drain and the source of the switch when the switch is on leads to a signal having a low slope, which makes determining the point at which the switch should be turned off difficult because the input and output voltages are approaching the same value. This condition makes using the derivative of the voltage at the antenna (the voltage at the node C 910) practical when attempting to determine the optimal point at which to turn off the first switch 706 and the second switch 707 because at node C 910, the ZC (zero current) point 833 coincides with the point in time that the voltage across the first switch 706 and the second switch 707 is at zero.

Switching off the switch 706 at the ZC (zero current) point 833 (and the switch 707 at the ZC (zero current) point 837) is desirable because the efficiency of the rectifier circuit 704 is greatly enhanced.

In an exemplary embodiment, the rectifier control signal on connection 758 causes the switches 706 and 707 in the synchronous rectifier 900 to switch off when the current in the first switch 706 and the second switch 707 is at or near zero at the ZC point 833 and the ZC point 837 in FIG. 8. The zero voltage crossing point of the derivative of the voltage at the resonator at node C 910 correlates with the zero current point of the first switch 706 and the second switch 707.

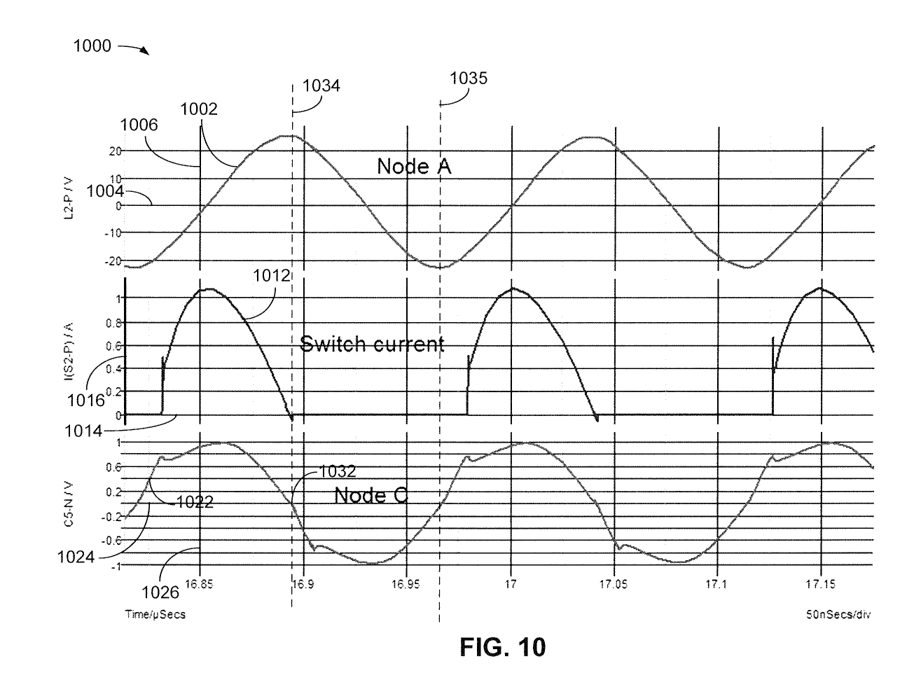

FIG. 10 is a timing diagram 1000 showing the timing of various signals of FIG. 9. The timing diagram 1000 shows a trace 1002 representing the voltage at node A 748 (FIG. 7). The horizontal axis 1004 shows time increasing to the right and the vertical axis 1006 shows voltage. The trace 1002 is a generally sinusoidal waveform of the resonant voltage signal developed by the receive coil 718 (FIG. 7).

The timing diagram 1000 also shows a trace 1012 representing the current in the first switch 706 (FIG. 7). The horizontal axis 1014 shows time increasing to the right and the vertical axis 1016 shows current.

The trace 1022 represents the signal at node C 910, which represents the derivative of the signal at node A 748. The horizontal axis 1024 shows time increasing to the right and the vertical axis 1026 shows voltage. The trace 1022 representing the voltage at node C 910 crosses the zero voltage point 1032 at the same point in time 1034 that the voltage at node A 748 is at its peak, or maximum voltage level, and the current in the first switch 706 is zero, or at its minimum current level as shown by trace 1012. Using the signal at node C 910 instead of the signal at node A 748 to determine the point at which the voltage signal 1002 at node A 748 is at a maximum voltage level (and therefore, at zero current) and as the input to the buffer 754 may simplify the design of the wireless power receiver 700 by simplifying the identification of the ZC point 833 and ZC point 837 (FIG. 8) because it is easier to observe the point at which the trace 1022 crosses the zero voltage point 1032 than it is to observe the point at which the trace 1002 is at its peak, or maximum voltage level, at point 1034, or at its minimum voltage level at point 1035, which also coincides with a zero voltage level of trace 1022.

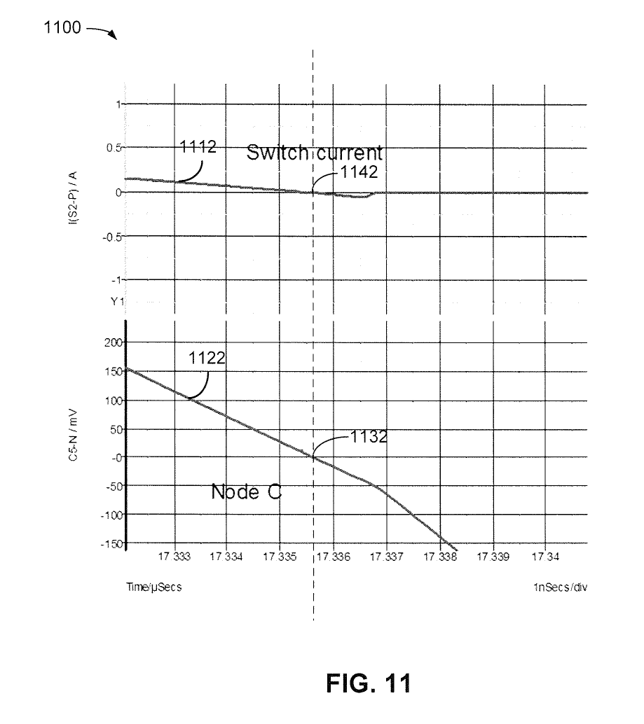

FIG. 11 is a timing diagram 1100 showing a detail of a trace 1122 representing the signal at node C of FIG. 9 and a trace 1112 representing the current in the first switch 706 of FIG. 9. The trace 1112 shows a portion of the trace 1012 of FIG. 10 as it passes the zero current point 1142 and the trace 1122 shows a portion of the trace 1022 of FIG. 10 as it passes the zero voltage point 1132. The traces 1112 and 1122 confirm that when the signal at node C 910 (FIG. 9), which represents the derivative of the signal at node A 748, is at zero volts (which corresponds to a peak of the trace 1022 representing the signal at node C 910 (FIG. 9), then the current in the first switch 706 (FIG. 7) is zero, and that the derivative of the signal at node A can be used as a reliable indication of the point in time when the generally sinusoidal waveform of the resonant voltage signal developed by the receive coil 718 (FIG. 7) is at a peak.

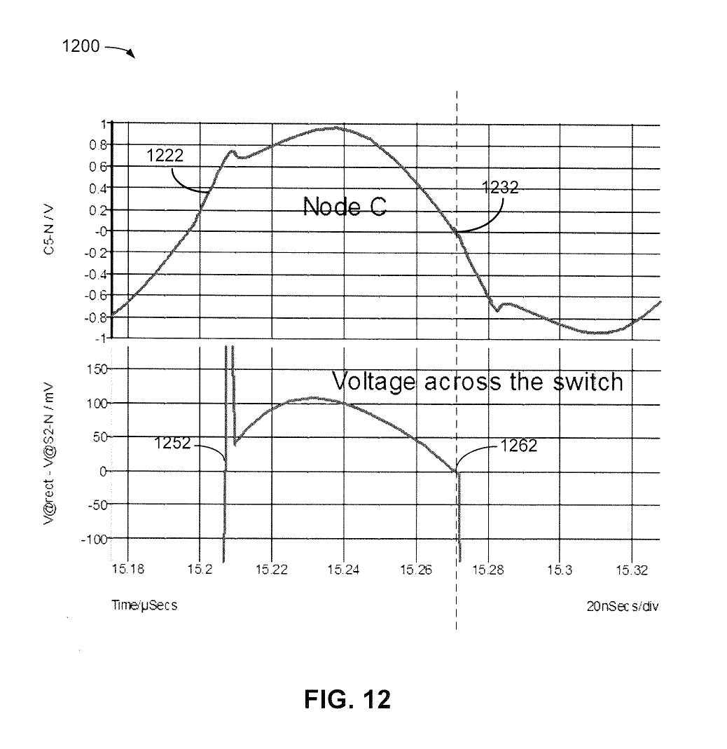

FIG. 12 is a timing diagram 1200 showing a detail of a trace 1222 representing the signal at node C and a trace 1252 representing the voltage across the first switch 706 of FIG. 9. The trace 1222 shows a portion of the trace 1022 of FIG. 10 as it passes the zero voltage point 1232 and the trace 1252 shows the voltage across the first switch 706 (FIG. 7) at a point 1262 that corresponds in time to the point 1232 of the trace 1222.

In an exemplary embodiment, the amplitude of the signal shown by trace 1222 is significantly larger than the amplitude of the signal across the switch shown by the trace 1252 making the design of a comparator that can be used to sample the voltage at node C (FIG. 9) much simpler than a comparator that samples the voltage at node A 748 (FIG. 7).

As stated above, the trace 1222 shows the derivative (at node C (FIG. 9)) of the signal at node A 748 (FIG. 7), and the amplitude of the derivative signal depends on the induced voltage; however, a proper selection of the circuit (or an adaptive circuit) generates sufficient overdrive.

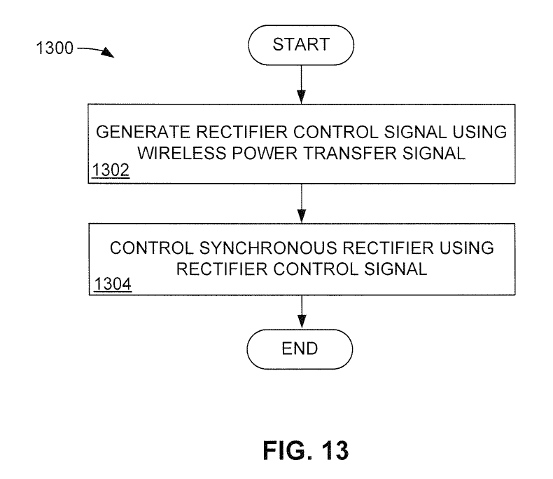

FIG. 13 is a flowchart illustrating an exemplary embodiment of a method 1300 for controlling a synchronous rectifier in a wireless power receiver. The blocks in the method 1300 can be performed in or out of the order shown. The description of the method 1300 will relate to the various embodiments described herein.

In block 1302, a rectifier control signal based on the wireless power transfer signal is generated. In an exemplary embodiment, the rectifier control signal may be responsive to the resonant voltage signal developed by the receive resonator.

In block 1304, a synchronous rectifier is controlled using the rectifier control signal. In an exemplary embodiment, the rectifier control signal controls the switches in the synchronous rectifier.

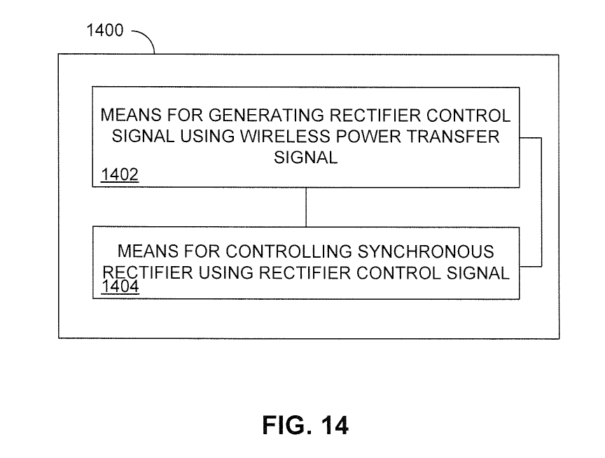

FIG. 14 is a functional block diagram of an apparatus 1400 for controlling a synchronous rectifier in a wireless power receiver. The apparatus 1400 comprises means 1402 for generating a rectifier control signal based on the wireless power transfer signal. In certain embodiments, the means 1402 for generating a rectifier control signal based on the wireless power transfer signal can be configured to perform one or more of the function described in operation block 1302 of method 1300 (FIG. 13). In an exemplary embodiment, the means 1302 for generating a rectifier control signal based on the wireless power transfer signal may comprise the receive circuitry and rectifier circuitry described herein.

The apparatus 1400 further comprises means 1404 for controlling a synchronous rectifier using the rectifier control signal. In certain embodiments, the means 1404 for controlling a synchronous rectifier using the rectifier control signal can be configured to perform one or more of the function described in operation block 1304 of method 1300 (FIG. 13). In an exemplary embodiment, the means 1404 for controlling a synchronous rectifier using the rectifier control signal may comprise the receive circuitry and rectifier circuitry described herein.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

In view of the disclosure above, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the FIGS. which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and Blu-Ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

1. An apparatus for wirelessly receiving power via a wireless field generated by a transmitter, the apparatus comprising:
a resonator configured to generate electrical current to power or charge a load based on a voltage induced in the resonator in response to the wireless field;
a controller configured to receive a synchronization timing reference signal based on a derivative of the voltage induced in the resonator, the controller configured to generate a rectifier control signal based on the synchronization timing reference signal; and
a synchronous rectifier configured to switch responsive to the rectifier control signal.

2. The apparatus of claim 1, wherein the synchronous rectifier comprises a first switch and a second switch and the rectifier control signal comprises a first rectifier control signal that controls the first switch and a second rectifier control signal that controls the second switch.

3. The apparatus of claim 1, wherein the rectifier control signal is responsive to a maximum or a minimum of the voltage induced in the resonator.

4. The apparatus of claim 1, wherein the derivative of the voltage induced in the resonator is generated using a resistive (R) and capacitive (C) filter.

5. The apparatus of claim 4, wherein the resistive (R) and capacitive (C) filter comprises a first capacitor coupled in parallel with the resonator and a second capacitor coupled in series with a resistor, the second capacitor and the resistor coupled in parallel with the first capacitor whereby the derivative of the voltage induced in the resonator appears at a node located between the second capacitor and the resistor.

6. The apparatus of claim 1, wherein the synchronous rectifier is a half bridge rectifier.

7. The apparatus of claim 1, wherein the synchronous rectifier is a full bridge rectifier.

8. The apparatus of claim 1, wherein the derivative of the voltage induced in the resonator comprises a zero voltage level when the voltage induced in the resonator is at a maximum voltage level or a minimum voltage level.

9. The apparatus of claim 8, wherein a current induced in the resonator is at a minimum current level and the rectifier control signal causes the synchronous rectifier to switch off when the current induced in the resonator is at the minimum current level.

10. The apparatus of claim 1, wherein the controller adjusts the rectifier control signal to establish a variable delay that establishes a phase displacement between the rectifier control signal and the synchronization timing reference signal.

11. The apparatus of claim 10, wherein the variable delay is configured to control an amount of power provided to the load.

12. A method for wirelessly receiving power via a wireless field generated by a transmitter, the method comprising:
generating an electrical current to power or charge a load based on a voltage induced in a resonator in response to the wireless field;
generating a synchronization timing reference signal based on a derivative of the voltage induced in the resonator;
generating a rectifier control signal based on the synchronization timing reference signal; and
rectifying the electrical current based at least in part on the rectifier control signal.

13. The method of claim 12, wherein generating the rectifier control signal comprises:
generating a first rectifier control signal that controls a first switch; and
generating a second rectifier control signal that controls a second switch.

14. The method of claim 12, wherein the rectifier control signal is responsive to a maximum or a minimum of the voltage induced in the resonator.

15. The method of claim 12, further comprising using a resistive (R) and capacitive (C) filter to generate the derivative of the voltage induced in the resonator.

16. The method of claim 12, wherein the derivative of the voltage induced in the resonator comprises a zero voltage level when the voltage induced in the resonator is at a maximum voltage level or a minimum voltage level and a current induced in the resonator is at a minimum current level and the rectifier control signal causes the rectified electrical current to switch off when the current induced in the resonator is at the minimum current level.

17. The method of claim 12, further comprising variably delaying the rectifier control signal with respect to the synchronization timing reference signal.

18. The method of claim 17, wherein variably delaying the rectifier control signal controls an amount of power provided to the load.

19. A device for wirelessly receiving power via a wireless field generated by a transmitter, the device comprising:
means for generating an electrical current to power or charge a load based on a voltage induced in response to the wireless field;
means for generating a synchronization timing reference signal based on a derivative of the voltage induced in the means for generating the electrical current;
means for generating a rectifier control signal based on the synchronization timing reference signal; and
means for receiving the rectifier control signal and based thereon, providing a regulated voltage.

20. The device of claim 19, wherein the means for generating a rectifier control signal comprises:
means for generating a first rectifier control signal that controls a first switch; and
means for generating a second rectifier control signal that controls a second switch.

21. The device of claim 19, wherein the means for generating the rectifier control signal is responsive to a maximum or a minimum of the induced voltage.

22. The device of claim 19, wherein the means for generating the derivative of the voltage comprises resistive (R) and capacitive (C) means.

23. The device of claim 19, wherein the means for generating the rectifier control signal comprises means for variably delaying the rectifier control signal with respect to the synchronization timing reference signal.

24. The device of claim 23, further comprising means for controlling an amount of power provided to the load by controlling the variable delay.

25. An apparatus for wirelessly receiving power via a wireless field generated by a transmitter, the apparatus comprising:
a resonator configured to generate electrical current to power or charge a load based on a voltage induced in the resonator in response to the wireless field;
a controller configured to receive a synchronization timing reference signal based on a derivative of the voltage induced in the resonator, the derivative of the voltage induced in the resonator being generated using a resistive (R) and capacitive (C) filter, the controller configured to generate a first control signal configured to control a first switch and a second control signal configured to control a second switch; and
a synchronous rectifier comprising the first switch and the second switch, the synchronous rectifier configured to receive the first control signal and the second control signal and configured to provide a regulated voltage.

26. The apparatus of claim 25, wherein the first rectifier control signal and the second rectifier control signal are responsive to a maximum or a minimum of the voltage induced in the resonator.

27. The apparatus of claim 25, wherein the synchronous rectifier is chosen from the group consisting of a half bridge rectifier and a full bridge rectifier.

28. The apparatus of claim 25, wherein the derivative of the voltage induced in the resonator comprises a zero voltage level when the voltage induced in the resonator is at a maximum voltage level or a minimum voltage level and a current induced in the resonator is at a minimum current level and the first and second control signals cause the synchronous rectifier to switch off when the current induced in the resonator is at the minimum current level.

29. The apparatus of claim 25, wherein the controller adjusts the first and second control signals to establish a variable delay that establishes a phase displacement between at least the first and second control signals and the synchronization timing reference signal.

30. The apparatus of claim 29, wherein the variable delay is configured to control an amount of power provided to the load.
